(19) United States
(12) Patent Application Publication
(10) Pub. No.: US 2021/0172218 A1
(43) Pub. Date: Jun. 10, 2021

(54) DOOR HANDLE ASSEMBLY FOR A MOTOR VEHICLE

(71) Applicant: Huf Hülsbeck & Fürst GmbH & Co. KG, Velbert (DE)

(72) Inventor: Mensur Velicanin, Velbert (DE)

(73) Assignee: Huf Huelsbeck & Fuerst GmbH & Co. KG, Velbert (DE)

(21) Appl. No.: 16/624,155

(22) PCT Filed: Jun. 4, 2018
(86) PCT No.: PCT/EP2018/064639

§ 371 Date: Dec. 18, 2019

(30) Foreign Application Priority Data
Jul. 13, 2017 (DE) 10 2017 115 789.1
Aug. 4, 2017 (DE) 10 2017 117 722.1

(51) Int. Cl. E05B 85/10; E05B 79/06; E05B 79/20; E05B 81/90

(52) U.S. Cl. CPC E05B 85/107; E05B 79/06; E05Y 2900/531; E05B 81/90; E05B 79/20

(57) ABSTRACT

A door handle assembly for a motor vehicle includes a handle support, a handle and a drive element. The handle can assume an idle position and a handling position. The handle extends flush with the outside of a vehicle door in the idle position and projects outward of the vehicle door for actuation in the handling position. A base plate is movably mounted on the handle support and can be moved relative to the handle support. The handle is mounted on the base plate. The drive element is kinematically coupled to the base plate. In normal operation, the drive element moves the base plate from a basic position, in which the handle is arranged in the idle position, into a standby position, in which the handle is arranged in the handling position.

The invention relates to a door handle assembly for a motor vehicle, comprising a handle support, a handle and a drive element. The handle can assume at least an idle position and a handling position. In case of installation in a vehicle door, the handle extends flush with the outside of the vehicle door in the idle position and projects outward in a projection direction relative to the outside of the vehicle door for actuation in the handling position.

Such door handle assemblies for a motor vehicle can be designed as an inner or outer handle, wherein the present invention relates to a door handle assembly for an outer handle. For this type of door handle assembly, there is a variety of different constructions and embodiments. The design of a door handle according to the invention relates to such constructions in which the handle support is attached to the rear side of the vehicle door, i.e. the inside of the vehicle. The handle applied to the handle support usually protrudes from the vehicle door in such embodiments and disturbs both the aesthetic impression of the motor vehicle and the vehicle aerodynamics. In order to avoid these disadvantages, there are known prior art door handle assemblies in which the outside of the handle in its idle position, in which it is not used, runs approximately flush with the outer contour of the vehicle door, i.e. extends flush to the surface. Such a handle can be transferred to a handling position for opening the vehicle door, in which the handle protrudes compared to the outer contour of the vehicle door.

A door handle assembly of the type described in the introduction is known, for example, for electric cars from Tesla Motors Inc. and from DE 10 2013 212 198 A1. This known door handle assembly has a handle arranged flush in its idle position, which is movable by a motor from the idle position into a handling position. Such a handle is preferably used in electric cars, in which the handle extends exclusively with a current-driven drive from its flush idle position, in which the handle for reducing the air resistance is arranged, in the handling position when an authorized operator approaches the motor vehicle. Once the handle is no longer needed, it returns to the idle position and disappears into the vehicle body to avoid producing air resistance. The disadvantage is that the door handle assembly has a complex structure for the extension mechanism and an associated large installation depth.

The object of the invention is to provide a solution that provides an improved door handle assembly for a motor vehicle in a structurally simple manner, the door handle assembly having a space-saving design with low installation depth while still allowing comfortable operation.

In a door handle assembly of the type described, the object is achieved in that on the handle support a base plate is movably mounted, which is movable relative to the handle support and on which base plate the handle is mounted, wherein the drive element is kinematically coupled to the base plate and in normal operation, the drive element is designed to move the base plate from a basic position, in which the handle is arranged in the idle position thereof, into a standby position, in which the handle is arranged in the handling position thereof. For the purposes of the invention, the current-driven normal operation represents a mode in which the drive element then moves the handle from the idle position to the handling position when an authorized operator approaches the motor vehicle with his ID transmitter. In the handling position, the authorized operator can then grip behind the handle and pull it to open the motor vehicle door. The movement of the base plate during the projection movement of the handle is directed in the projection direction.

Advantageous and expedient embodiments and developments of the invention are disclosed in the dependent claims.

The invention provides a door handle assembly for a motor vehicle characterized by a simple construction with low installation depth. Characteristic of the invention is the small number of components that are required for the extension of the handle from the idle position to the handling position. For extending the handle in the handling position, only the base plate is provided on which the handle is mounted. According to the invention, the handle is arranged in its idle position when the base plate is arranged in its basic position. If the base plate is moved from the basic position by a movement in the projection direction into the standby position, the handle mounted on the base plate moves with the base plate and enters its handling position, without the handle moving relative to the base plate. The handle is thus mounted on the base plate, which advantageously increases the stability of the handle.

The invention provides, in an advantageous embodiment, that the handle is arranged unmoved on the base plate upon a movement of the base plate from the basic position to the standby position, wherein the base plate is designed to move the handle from the idle position into the handling position. The base plate thus represents the only component which serves to project the handle in the handling position, so that an operator can grip behind the handle in the handling position and actuate said handle to open the vehicle door.

In an embodiment of the invention, it is further provided that the handle is mounted movable on the base plate relative to the base plate, wherein a first longitudinal end of the handle is pivotally mounted on the base plate, whereas a second longitudinal end of the handle is formed to be pivoted by an operator in the projection direction and is connected to a vehicle door opening means. It is therefore a handle on which an operator must pull to open the vehicle door in normal operation, in which the handle is electrically projected by the drive element, the handle then assumes an inclined position, aligned transversely to the handle support.

For the handling of the door handle assembly to open the vehicle door in an emergency, in which the power supply is interrupted or has failed and the handle is not electrically moved to the projected handling position, the invention provides in a further embodiment that the handle is movable from the idle position into an emergency operating position, in which a first portion of the handle moves contrary to the projection direction and a second portion of the handle projects outward in a projection direction relative to the outside of the vehicle door. Due to the pivotable mounting, it is consequently possible to press the handle on a portion, preferably on one longitudinal end, against the deployment direction in the direction of the handle support, so that this portion disappears within the body. In this case, another portion of the handle, preferably a portion of the other longitudinal end of the handle, projects relative to the vehicle door and can be gripped by an operator to manually move the entire handle in the handling position, from where it is possible to pull on the handle for opening the vehicle door.

To move the handle to the emergency operating position, the invention provides in a further embodiment that the handle has a handle outer shell and a handle main lever, wherein a first longitudinal end of the handle outer shell is pivotally mounted at a first longitudinal end of the handle main lever, wherein the handle main lever is pivotally mounted on the base plate with its first longitudinal end, and wherein in the emergency operating position of the handle, the first longitudinal end of the handle outer shell is arranged to be movable opposite to the projection direction and the first longitudinal end of the handle outer shell is arranged relatively movable to the first longitudinal end of the handle main lever. In this case, the handle main lever is coupled to the vehicle opening means, so that the connection of the handle outer shell and handle main lever for decoupling ensures such that, in a de-energized emergency operation, a movement of the handle only the handle outer shell is pivoted into the emergency operating position. The handle main lever coupled with the vehicle opening means remains unmoved, so there is no danger that the vehicle opening means is accidentally triggered in a movement into the emergency operating position.

For preventing the handle outer shell from pivoting in a normal operation relative to the handle main lever, when the handle is pulled to open the vehicle door by the operator, the invention provides in an embodiment that at the second longitudinal end of the handle outer shell, a latching recess is formed, wherein a safety lever blocking a relative movement between the handle outer shell and handle main lever is pivotally mounted with a latching hook on the handle main lever, and wherein the latching hook is engaged with the latching recess in the handling position of the handle. In this way, it is ensured that the handle outer shell and the handle lever pivot together in normal operation when an operator pulls on the handle for opening the vehicle door.

In order to engage the latching hook of the safety lever with the recess, there is a particularly favorable design option that the moving web is formed on the handle support and the safety lever, which is disengaged from the locking recess in the idle position of the handle, is pivotally mounted about the axis on the handle main lever, wherein the moving web is designed to pivot the safety lever during the movement of the handle from the idle position into the handling position of the handle about the axis and to engage the latching hook with the latching recess in the handling position of the handle.

According to one embodiment of the invention, it is provided that the drive element rotatably drives a drive axis and the base plate is movably supported by at least one rotary joint on the handle support between the basic position and the standby position, wherein the at least one rotary joint is non-rotatably connected to the drive axis. It is of course also conceivable that the base plate is movably mounted at each of its two longitudinal ends via a respective rotary joint on the handle support, wherein it is then sufficient if one of the two rotational joints is drivingly connected to the drive element and driven by the drive element. The rotary joint has the advantage that the raising movement of the handle on the movement of the base plate is well defined and limited. By pulling on the handle, the handle cannot project beyond its handling position, because the base plate can only be moved as far in the projection direction as the rotary joint allows. Also, a pulling movement for opening the vehicle door is possible, wherein the handle is here pivoted relative to the base plate but the base itself is not moved.

Accordingly, in an embodiment of the invention, it is provided that the at least one rotary joint is designed to be lever-shaped and a first lever end of the rotary joint is rotatably connected to the base plate and a second lever end of the rotary joint is both non-rotatably connected to the drive axle and rotatably mounted on the handle support. Due to this dual function of the drive lever (rotatable bearing on the handle support and non-rotatable connection with the drive axis), the lever turns around the axis on which it is driven at the same time, which reduces the space requirement.

In another embodiment, the invention provides that the base plate is movably guided along at least one guide rod extending transversely to the handle support between the basic position and the standby position. Of course, the base plate may also have at each of its two longitudinal ends in each case a guide rod, whereby the base plate is held stable and securely guided.

According to the other embodiment, the invention provides in this related design that the drive element is coupled for movement with a lever axis to the drive lever which is rotatably mounted on the handle support, wherein the drive lever has at its free end a drive pin, which is arranged within such a slot aligned transversely to the projection direction and formed in the base plate, that the drive element moves the drive pin on the drive lever within the slot whereby the drive pin presses the base plate in its standby position. In this way, a kind of guide slot is formed, through which the base plate is pressed into its standby position.

In order to realize the movement of the base plate in the projection direction, the invention provides in an embodiment that the drive element drives a coupling lever which is rotatable about an axis of rotation in normal operation, wherein a free end of the coupling lever is formed with a coupling pin which abuts the drive lever upon movement of the handle from the idle position into the handling position and rotates said handle about its lever axis.

In order to further block the movement of the base plate in the projection direction, a stop element could be provided on the at least one guide rod. As an alternative to a stop element, the invention provides for the coupling pin to be arranged in the standby position of the base plate in a pin receptacle formed on the drive lever, wherein movement of the base plate beyond the standby position in the projection direction is blocked when the coupling pin is arranged in the pin receptacle.

For moving the base plate into its standby position, the invention according to yet another embodiment provides that the drive element drives a toothed belt and the base plate is movably supported by at least one spindle element on the handle support between the basic position and the standby position, wherein the at least one spindle element is non-rotatably connected to a toothed belt pulley driven by the toothed belt. In this way, a very accurate positioning of the base plate in its standby position and thus the handle in its handling position can be realized.

The invention provides in a design of yet another embodiment, that the toothed belt pulley is rotatably mounted on the handle support and the at least one spindle element cooperates with a spindle nut which is rotatably mounted on the base plate.

Finally, according to the invention it is provided in a design of yet another embodiment, that a spindle nut is rotatably mounted at a respective longitudinal end of the base plate, which spindle nut cooperates with an associated spindle element which is non-rotatably connected to a toothed belt pulley which is rotatably mounted on the handle support. In this way, it is ensured that both longitudinal ends of the base plate are moved uniformly and evenly, so that the handle is moved linearly into the handling position, transversely to the handle support.

It goes without saying that the features mentioned above and those to be explained below can be used not only in the combination indicated but also in other combinations or in a unique position, without leaving the scope of this invention. The scope of the invention is defined only by the claims.

Other details, features, and advantages of the subject matter of the invention can be found in the following description in connection with the drawing, in which exemplary and preferred design examples of the invention are presented.

In the drawing:

FIG. 1 shows a schematic side view of a motor vehicle with a plurality of door handle assemblies according to the invention,

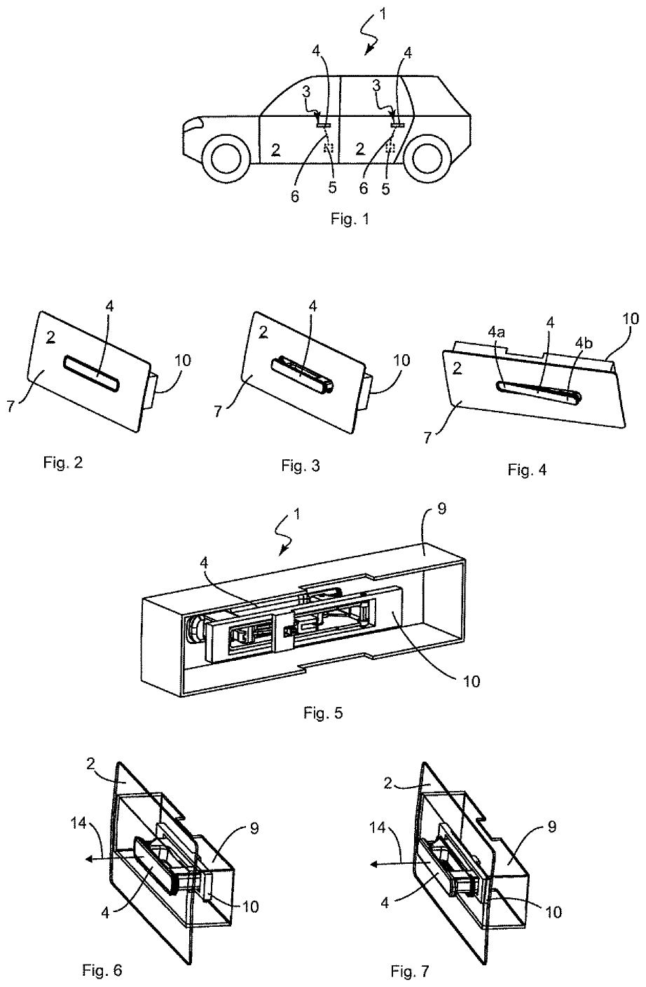

FIG. 2 shows a perspective view of the door handle assembly according to the invention having a handle arranged flush or areally flush with the outside of a vehicle door in an idle position,

FIG. 3 shows a perspective view of the door handle assembly according to the invention with a handle arranged in a handling position,

FIG. 4 shows a perspective view of the door handle assembly according to the invention having a handle arranged in an emergency operating position,

FIG. 5 shows a perspective back view of the door handle assembly according to the invention,

FIG. 6 shows a perspective view of the handle mounted on a base plate arranged in a basic position in the idle position,

FIG. 7 shows a perspective view of the handle in the handling position which handle is mounted on the base plate arranged in a standby position,

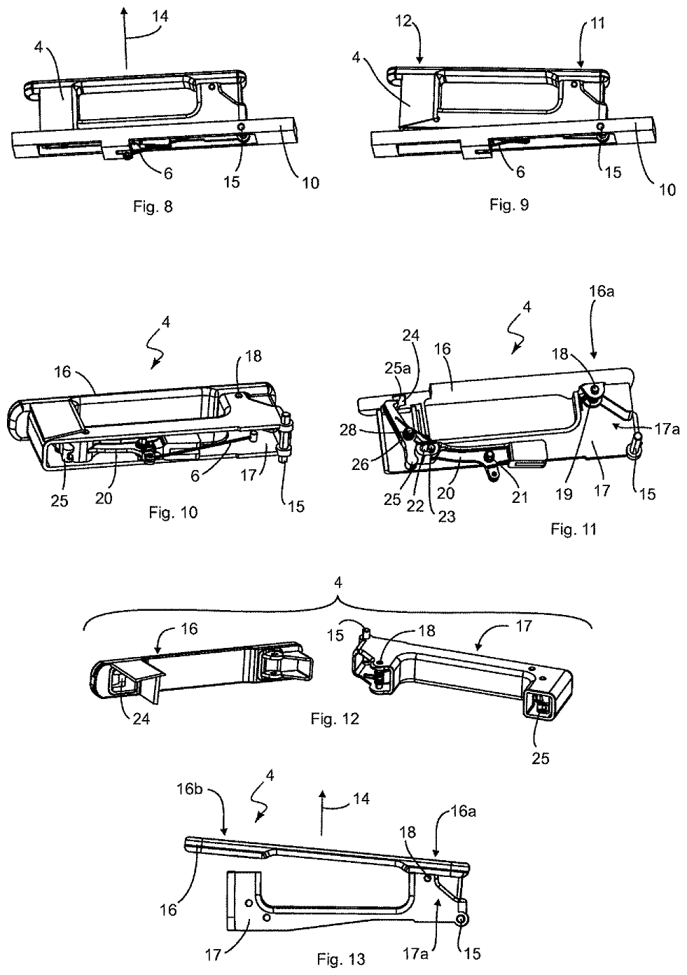

FIG. 8 shows a perspective view of the base plate and the handle arranged in its handling position,

FIG. 9 shows a perspective view of the base plate and the handle arranged pivoted out of its handling position,

FIG. 10 shows a perspective view of the handle,

FIG. 11 shows a perspective sectional view of the handle shown in FIG. 10,

FIG. 12 shows a perspective detail view of the handle having a handle shell and a handle main lever,

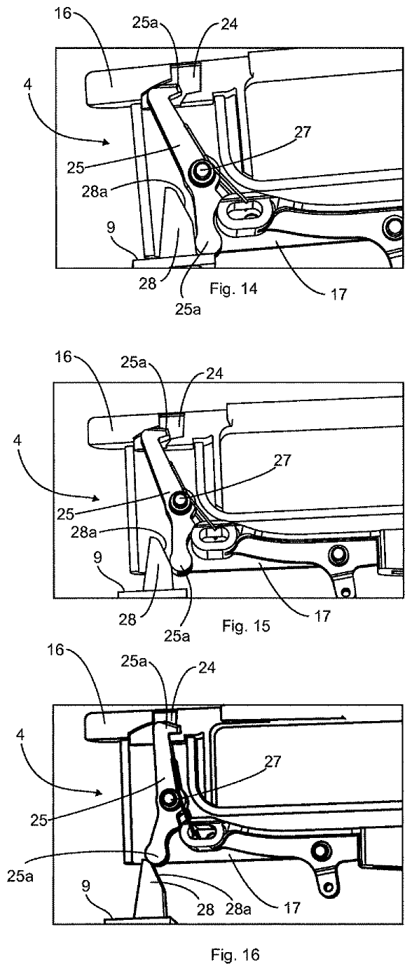

FIG. 13 shows a perspective sectional representation of the handle in its emergency operation,

FIG. 14 shows a perspective detail sectional view of the handle having a securing lever in its idle position,

FIG. 15 shows a further perspective detail sectional view of the handle having the securing lever in a position between its idle position and its handling position,

FIG. 16 shows a further perspective detail sectional view of the handle having a securing lever in its handling position,

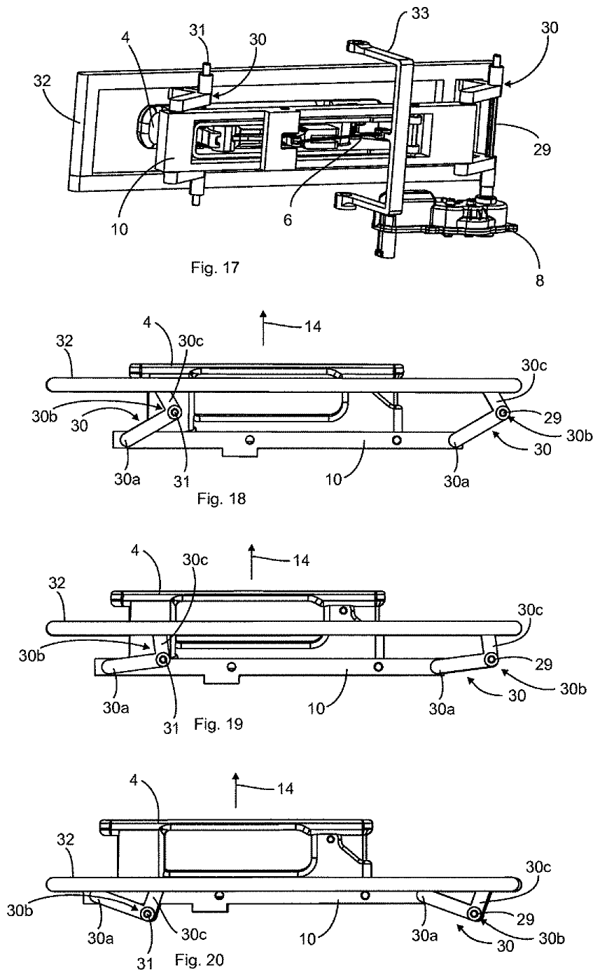

FIG. 17 shows a perspective view of a first embodiment of a door handle assembly according to the invention,

FIG. 18 shows a plan view of FIG. 17 with the door handle assembly arranged in its idle position,

FIG. 19 shows a plan view of the door handle assembly shown in FIG. 17 with the handle in the position between the idle position and the handling position,

FIG. 20 shows a plan view of FIG. 17 with the door handle assembly arranged in its handling position,

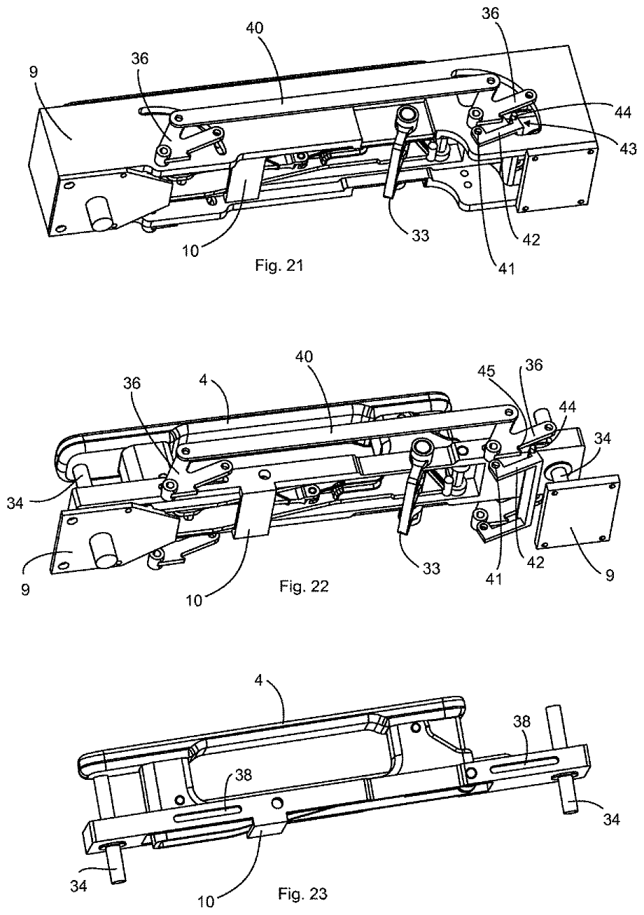

FIG. 21 is a perspective view of a second embodiment of a door handle assembly according to the invention,

FIG. 22 shows a perspective sectional view of the door handle assembly of the second embodiment,

FIG. 23 shows a perspective top view of the handle which is movably mounted on the base plate according to the second embodiment,

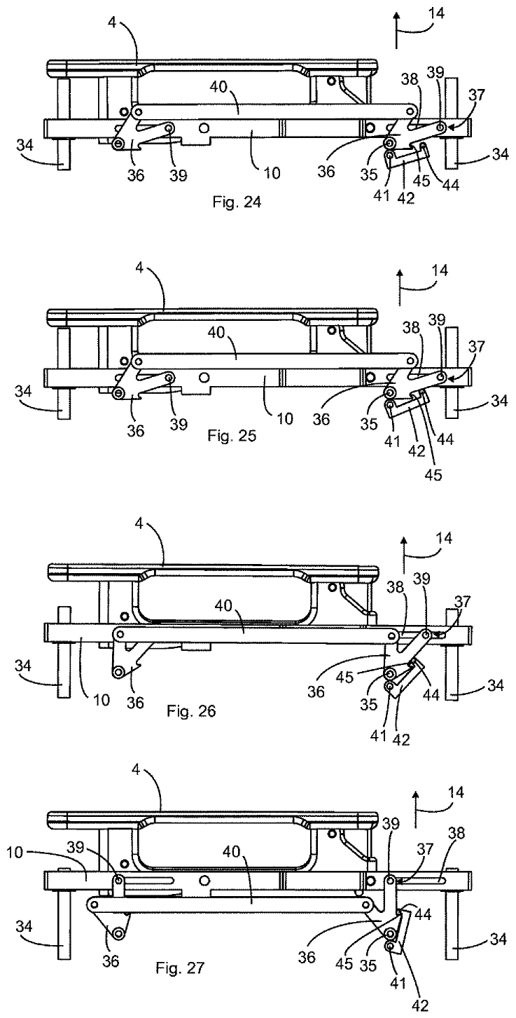

FIG. 24 shows a plan view of the base plate shown in FIG. 23 and the handle movably mounted on the base plate in its idle position,

FIG. 25 shows a further plan view of the base plate shown in FIG. 23 and the handle movably mounted on the base plate in a first intermediate position between their idle position and its handling position,

FIG. 26 shows a further plan view of the base plate shown in FIG. 23 and the handle movably mounted on the base plate in a second intermediate position between their idle position and its handling position,

FIG. 27 shows a further plan view of the base plate shown in FIG. 23 and the handle movably mounted on the base plate in its handling position,

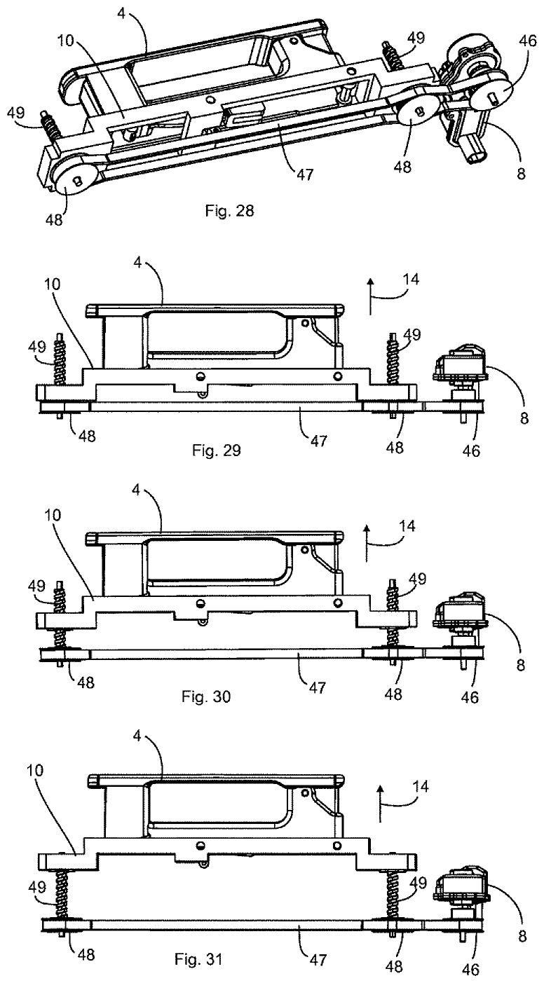

FIG. 28 shows a perspective top view of the handle which is movably mounted on the base plate according to a third embodiment of the invention,

FIG. 29 shows a plan view of FIG. 28 with the handle arranged in its idle position,

FIG. 30 shows a plan view of FIG. 28 with the handle arranged between its idle position and its handling position and

FIG. 31 shows a plan view of FIG. 28 with the handle arranged in its handling position.

FIG. 1 shows an example of a motor vehicle 1 represented in the shape of a passenger car, which in the example has four vehicle doors 2 (two of which are shown in FIG. 1) which can be opened via a respective door handle assembly 3 and in particular with the aid of a handle 4 of the door handle assembly 3. The vehicle doors 2 are firmly locked via a respective door lock 5 and can only be opened from the outside via a respective movement of the handle 4. This movement on the handle 4 consists of a pulling movement, wherein the corresponding movement of the handle 4 is transmitted to the corresponding lock 5 via a vehicle door opening means 6, which in the present case is a Bowden cable system. The associated vehicle door 2 can be opened with the corresponding movement of the handle 4. In the case of a de-energized emergency operation, the door handle assembly 3 is formed, so that the manual opening of the vehicle door 2 is possible by actuation of the handle 4 effected by an operator.

FIG. 2 shows in perspective view one of the vehicle doors 2 and the handle 4 which serves for the opening of the vehicle door 2. In FIG. 2, the handle 4 is arranged approximately flush to the outside 7 of the vehicle door 2, i.e. flush or areally flush, when the door handle assembly 3 is installed in the vehicle door 2. In this position, the handle 4 is in an idle position in which it is not used. From the idle position shown in FIG. 2, the handle 4 can be transferred into a handling position shown in FIG. 3, in which it protrudes relative to the outside 7 of the vehicle door 2. Accordingly, the handle 4 in its handling position is arranged to protrude from the vehicle door 2. In this protruding handling position or when extended from the outside 7, an operator can reach behind handle 4 and actuate or act upon said handle, in order to open the vehicle door 2. According to the present invention, the transfer of the handle 4 from the idle position to the handling position is carried out in a current-driven normal operation by means of a drive element 8 (see, for example, FIGS. 13 and 24). For the current-driven normal operation, proximity sensors or other sensors may be provided to move the handle 4 from the flush or areally flush idle position to the standby position as soon as an operator approaches the vehicle door handle 3 or handle 4. For this purpose, sensors known from the prior art proximity may be installed in the handle 4, which sensors send a signal to a vehicle control device upon detection of an authorized operator or ID transmitter, whereby the drive element 8 is put into operation and causes the projection of the handle 4 in the handling position. In a de-energized emergency operation, for example in the event of a failure of the vehicle electronics or vehicle supply, the handle can be manually moved by an operator from the idle position into an emergency operating position shown in FIG. 4. In the emergency operating position, a first portion 4a of the handle 4 is arranged pressed inward into the outside 7 of the vehicle door 2 and a second portion 4b of the handle 4 projects outward relative to the vehicle door 2. Thus, in a de-energized emergency operation, the handle 4 can be arranged in its emergency operating position, in that an operator presses the first portion 4a of the handle 4 inwardly with respect to the vehicle door 2 so that the second portion 4b of the handle 4 is projected, wherein the handle can be gripped by the operator for transferring said handle 4 into its handling position, in which the vehicle door 2 can be opened by pulling the handle 4.

The door handle assembly 3 according to the invention is shown in FIG. 5 in a perspective rear view. The door handle assembly 3 comprises the handle 4 and a handle support 9, which can be attached on the inside of a vehicle door 2. The handle support stores or carries the other components of the door handle assembly 3, wherein components on the handle support 9 can be attached. In this case, the drive element 8 may be fastened to the handle support 9 or to the vehicle door 2 or in the region of the vehicle door 2. In FIGS. 2 to 4, the handle support 9 can be seen behind the outside 7 of the vehicle door. As can be seen from FIGS. 5 to 7, a base plate 10 is movably mounted on the handle support 9, which is movable relative to the handle support 9, wherein said base plate can be moved relative to the handle support, and the handle 4 is mounted on said base plate. FIGS. 6 and 7 show quasi-transparent views of the door handle assembly 3, wherein in FIG. 6, the base plate 10 is arranged in a basic position, while the handle 4 mounted on the base plate 10 is arranged in its idle position, whereas in FIG. 7, the base plate 10 is arranged in a standby position, while the handle 4 mounted on the base plate 10 is arranged in its handling position. As the comparison of the different positions of base plate 10 and handle 4 in FIGS. 6 and 7 shows, the handle 4 is moved during a movement of the base plate 10 from the basic position to the standby position without moving relative to the base plate 10. Consequently, the handle 4 is moved during a movement of the base plate 10 from the basic position to the standby position without the handle 4 moving relative to the base plate 10. Accordingly, the base plate 10 is formed to move the handle 4 from the idle position into the handling position, as will be discussed in detail below. The movement of the base plate 10 and the handle 4 takes place in a direction transverse to the handle support 9 aligned in the projection direction 14, which is shown in FIGS. 6 and 7, for example.

In FIG. 8, the base plate 10 is moved to its standby position, so that the handle 4 is arranged in its handling position. In the handling position, an operator can pull the handle 4 for opening the vehicle door 2, so that the handle 4 is arranged pivoted relative to the base plate 10, as shown in FIG. 9. By pivoting the handle 4, the vehicle door opening means 6 designed as a Bowden cable is actuated, such that the vehicle door 2 can be opened by pivoting. Consequently, the handle 4 is mounted on the base plate 10, said handle being movable relative to the base plate 10. More specifically, a first longitudinal end 11 of the handle 4 is pivotally mounted on the base plate 10, whereas a second longitudinal end 12 of the handle 4 can be pivoted by an operator in the projection direction 14 and is coupled to the vehicle door opening means 6. The handle 4 is thus pivotally mounted on the base plate 10 via a pivot axis 15 (see, for example, FIGS. 8 and 9) and is pivoted to open the vehicle door 2 by an operator from the handling position. For reasons of clarity, the handle support 9 is not shown in FIG. 6. Details of the coupling of base plate 10 and handle support 9 will be described in more detail below.

Previously, inventive features of the handle 4 are described with reference to FIGS. 10 to 16. The handle 4 is thus not designed as it is known from the prior art as one piece but rather as two pieces. As particularly shown in FIG. 12, the handle 4 comprises a grip outer shell 16, which can be gripped by an operator and on which the operator pulls to actuate or open the vehicle door 2, and a handle main lever 17. The handle outer shell 16 and the handle main lever 17 are connected to each other, wherein the handle main lever 17 is additionally rotatably connected to the base plate 10 via the pivot axis 15. In this case, a spring element ensures a return of the handle 4 in its handling position (see FIG. 8), when the handle 4 is pulled for opening the vehicle door 2 (see FIG. 9). A first longitudinal end 16a of the handle outer shell 16 is pivotally mounted at a first longitudinal end 17a of the handle main lever 17 via a coupling axis 18, wherein the handle main lever 17 is pivotally mounted with its first longitudinal end 17a on the base plate 10 via the pivot axis 15. In this case, a spring element 19 wound around the coupling axis 18 holds the handle outer shell 16 in the position shown in FIGS. 8 to 11.

The reason for the two-part design of the handle 4 can be found in the fact that the door handle assembly 3 is equipped with an emergency operation property for a de-energized emergency operation, so for a case when the drive element 8 cannot be energized to move the handle 4 from the idle position into the handling position. In such an emergency operation, the operator still has the option of manually moving the handle 4 into the handling position in order to open the vehicle door 2, For this purpose, the operator must apply a force contrary to the projection direction 14 at the first longitudinal end 16a of the handle outer shell 16 and push the handle outer shell 16 at its first longitudinal end 16a in the direction of the handle support 2 or contrary to the projection direction 14, whereby the handle outer shell 16 is pivoted about the coupling axis 18 contrary to the force of the spring element 19, which is indicated by way of example in FIG. 13. In FIG. 13, the handle 4 is arranged in an emergency operating position, characterized in that the first longitudinal end 16a of the handle outer shell 16 moves contrary to the projection direction 14 and the first longitudinal end 16a of the handle outer shell 16 moves relatively to the first longitudinal end 17a of the handle main lever 17. The handle 4 is thus designed to be movable from the idle position into the emergency operating position, in which a first portion 4a of the handle 4 moves contrary to the projection direction 14 and a second portion 4b of the handle 4 projects outward in a projection direction 14 relative to the outside 7 of the vehicle door 2. As shown in FIG. 13, the relative pivoting of the handle outer shell 16 and the handle main lever 17 about the coupling axis 18 causes the longitudinal end of the handle outer shell 16, which faces away from the first longitudinal end 16a, to be pivoted out in the projection direction and to be pivoted away from the longitudinal end of the handle main lever 17 facing away from the first longitudinal end 17a, as is also apparent from FIG. 4. In this position of the handle outer shell 16, an operator can grip the handle outer shell 16 and pull the entire handle 4 into the handling position, from where the vehicle door 2 can be opened by a pivoting movement of the handle 4. During the pivoting movement toward the opening of the vehicle door 2, the vehicle opening means 6 (see, for example, FIG. 6) designed as a Bowden cable is pulled by pivoting a lever-type Bowden cable carrier 20 about an axis of rotation 21. The pivoting movement of the spring-loaded Bowden cable carrier 20 is effected by the pivoting out of the handle 4 at its second longitudinal end 12 in that a pin 23, which is movably mounted in a slot 22 and non-movably fixed to the handle main lever 17, pivots the Bowden cable carrier 20 upon pivoting of the handle main lever 17, whereby the vehicle opening means 6 is pulled in the direction of the second longitudinal end 12 of the handle 4.

For preventing the handle 4 during normal operation, i.e. when opening the vehicle door 2, from moving into the emergency operating position in which the handle outer shell 16 is arranged pivoted relative to the handle main lever 17 and whereby the actuation of the Bowden cable 6 attached to the Bowden cable carrier is not possible or is insufficient for opening the vehicle door 2, a locking mechanism is provided to prevent a relative pivoting of the handle outer shell 16 and the handle main lever 17 for the actuation of the handle 4 in the door opening operation. This securing mechanism will be described below with reference to FIGS. 11 to 16. The securing mechanism comprises a latching recess 24 which is formed at a second longitudinal end 16b of the handle outer shell 16, and a safety lever 25 pivotally mounted on the handle main lever 17, which has a latching hook 25a and which is designed to block relative movement between the handle outer shell 16 and the handle main lever 17. The safety lever 25 is pivotally mounted about an axis 27 fixed to the handle lever 17 and is pressed by a spring element 26 into a position in which the latching hook 25a is in engagement with the latching recess 24, as shown for example in FIG. 16. In this position, in which the latching hook 25a is out of engagement with the latching recess 24, the handle 4 is arranged in its idle position, whereas in the handling position of the handle 4, the latching hook 25a engages with the latching recess 24 (see, for example, FIG. 16). FIG. 14 shows an arrangement in which the handle 4 is arranged in the idle position and the handle plate 10 in its basic position. In this position, the latching hook 25a of the safety lever 25 is out of engagement with the latching recess 24. In FIG. 15, an intermediate position is shown in which the extension of the base plate 10 has begun in the direction of the projection direction 14, wherein the handle 4 is arranged in a position between the idle position and the handling position and the base plate 10 is arranged between its basic position and its operating position. A lever arm 25b of the safety lever 25 applied to the latching hook 25a bears against a movement web 28, wherein the force of the spring element 26 permanently presses the lever arm 25b against the movement web 28. The movement web 28 is formed on the handle support 9, so that when the base plate 10 moves, the lever arm 25b moves along the movement web 25. In FIG. 15, the lever arm 25b has reached a position in which it rests against a slope 28a of the movement web 25. In this case, the slope 28a is formed pointing away from the first longitudinal end 16a of the handle outer shell 16. Upon further movement of the base plate 10, the slope 28a allows the lever arm 25b to rotate about the axis 27, with the lever arm 25b still abutting the slope 28a of the movement web 28. In this way, the latching hook 25a of the securing lever 25 moves into the latching recess 24, as shown in FIG. 16. In FIG. 16, the base plate 10 is arranged in its standby position and the handle 4 is arranged in its handling position, wherein the latching hook 25a of the safety lever 25 engages in the latching recess 24, Since the latching hook 25a is engaged with the latching recess 24, a movement of the handle shell 16 is blocked relative to the handle main lever 17, such that in the handling position of the handle 4, a movement into the emergency operating position is prevented. Generally, it should be noted that the moving web 28 is formed on the handle support 9 and the safety lever 25, which is disengaged from the locking recess 24 in the idle position of the handle 4, is pivotally mounted about the axis 27 on the handle main lever 17, wherein the moving web 28 is designed to pivot the safety lever 25 during the movement of the handle 4 from the idle position into the handling position of the handle 4 about the axis 27 and to engage the latching hook 25a with the latching recess 24 in the handling position of the handle 4.

Hereinafter, various embodiments will be described, which are directed to the movement of the base plate 10 from the basic position to the standby position. It is understood that the above-described aspects of the two-piece handle 4 and the safety lever 25 are present in all three embodiments, although not explicitly referred to hereinafter.

FIGS. 17 to 20 show a first embodiment in which the drive element 8 is fastened to the handle support 9 and rotatably drives a drive shaft 29. The drive shaft 29 is non-rotatably connected to a rotary joint 30. The rotary joint 30 itself is rotatably mounted on the handle support 9 and rotatably connected to a first longitudinal end 10a of the base plate 10. In this way, the base plate 10 is movably supported via the rotary joint 30 on the handle support 9 between the basic position and the standby position. At a second longitudinal end 10b of the base plate 10, said base plate is rotatably connected with the handle support 9 via a further rotary joint 30, wherein the axis 31 of the second rotary joint 30 is not driven, but only the drive shaft 29 is driven by the drive element 8 in order to move the base plate 10 from the basic position shown in FIG. 14 in the direction of the standby position. It is understood that a single rotary joint 30 may be sufficient, wherein the two rotary joints 30 used in the first embodiment provide very good stability and accurate guidance of the base plate 10 and thus the handle 4. As can be seen from FIGS. 17 to 20, the rotary joints 30 are each of a lever-shaped design. In this case, a respective first lever end 30a of the rotary joint 30 is rotatably connected to the base plate 10, whereas a second lever end 30b of the rotary joint 30 is both non-rotatably mounted to the drive shaft 29 and rotatably mounted on the handle support 9. More specifically, the rotary joints 30 are formed as an angle lever, wherein the lever arm 30c facing away from the first lever end 30a is connected to a drive frame 32 (see FIG. 17) which can be used for cooperation with a push button, for example to switch off the drive element 8, when the base plate 10 arrives in its standby position. The drive frame 32 moves transversely to the projection direction 14. FIG. 18 shows the base plate 10 in its basic position, from which it is moved in the projection direction 14. In this case, the base plate moves through an intermediate position, which is shown in FIG. 19, before it has reached its standby position shown in FIG. 20. In the standby position of the base plate 10, the handle 4 is arranged in its handling position 4, in which an operator can pull the handle 4 to open the door. The pulling movement is transmitted to the Bowden cable carrier 20 and from there to the vehicle door opening means or the Bowden cable 6, whereby an actuating lever 33, which is coupled with the Bowden cable 6 and rotatably mounted on the handle support 9, is pivoted, whereby the vehicle door 2 is opened.

FIGS. 21 to 27 show a second embodiment, wherein FIG. 21 shows the entire door handle assembly 3 according to the second embodiment, whereas in FIG. 22 the handle support 9 has been omitted for reasons of clarity. In the second embodiment, the base plate 10 is movably guided along guide rods 34 extending transversely to the handle support 9 between the basic position and the standby position, as shown in FIG. 23, in which only the base plate 10, the handle 4, and the guide rods 34 are shown. In this case, the guide rods 34 are received by through holes correspondingly formed in the base plate 10 and are provided with a sliding coating, so that the base plate 10 is movably guided without major friction losses. The guide rods 34 are attached to the handle support 9. Also conceivable would be a guide with only one guide rod or more than one guide rod, with two guide rods 30 provided at each end of the base plate 10 for a secure and stable guidance. The movement of the base plate 10 is a linear movement in the projection direction 14. The guide rods 30 are only intended for guidance. The actual movement of the base plate 10 is in turn caused by the drive element 8, which is motion-coupled with a drive lever 36 rotatably mounted about a lever axis 35 on the handle support 9. The drive lever 36 has at its free end 37 a drive pin 39, which is arranged within a slot 38 aligned transversely to the projection direction 14 and formed in the base plate 10, that the drive element 8 moves the drive pin 39 on the drive lever 36 within the slot 38, whereby the drive pin 39 presses the base plate 10 in its standby position (see, for example, FIGS. 24 to 27). Consequently, the movement of the base plate 10 is largely based on the principle of a slotted guide. The constellation of drive lever 36, drive pin 39 and slot 38 is located at both longitudinal ends of the base plate 10, wherein only one drive lever 36 is driven by the drive element 8 at one longitudinal end of the base plate 10. The driven drive lever 36 is operatively connected to the other drive lever 36 via a coupling linkage 40, so that the driven drive lever 36 drives the other drive lever 36 via the coupling linkage 40. The drive lever 36 is not driven directly by the drive element 8. Rather, the drive element 8 drives, in normal operation, a coupling lever 42 which is rotatable about a rotation axis 41. The coupling lever 42 is formed at its free end 43 with a coupling pin 44 which abuts the drive lever 36 upon movement of the handle 4 from the idle position into the handling position and rotates said drive lever about its lever axis 35, as shown in FIGS. 24 to 27. In FIG. 24, which shows the idle position of the handle 4 and the standby position of the base plate 10, while the coupling pin 44 is not yet abutting the drive lever 36, the coupling pin 44 abuts the drive lever 36 at the startup of the drive element 8 (see FIG. 25), which rotates the coupling lever 42 about the rotation axis 41, and presses said drive lever about its lever axis 35, whereby the drive pin 39 in turn pushes against the edge of the slot 38 and presses the base plate 10 in the projection direction 14, wherein the base plate 10 is only movable along the guide rods 34. In this way, the base plate 10 is moved along the guide rods 34, as shown in FIGS. 25 and 26. In FIG. 27, the base plate 10 has arrived in its standby position, in which the handle 4 is arranged in its handling position and is ready to be actuated by an operator to open the vehicle door 2. In the standby position of the base plate 10, the coupling pin 44 is arranged in the pin receptacle 45 formed on the drive lever 36. For the coupling pin 44 arranged in the pin receptacle 45, a movement of the base plate 10 is blocked beyond the standby position in the projection direction 14, as can be seen from FIG. 27.

FIGS. 28 to 31 show a third embodiment of the door handle arrangement 3 according to the invention, wherein a representation of the handle support 9 has been dispensed with for reasons of clarity. The drive element 8 is arranged laterally of the base plate 10 and drives a toothed belt pulley 46, which in turn drives a toothed belt 47. The toothed belt 47 extends parallel to the base plate 10 and drives two toothed belt pulleys 48 which are rotatably mounted on the handle support 9. The two toothed belt pulleys 48 are each arranged at the longitudinal ends of the base plate 10 and non-rotatably connected to a spindle element 49. The respective spindle elements 49 extend in the projection direction 14 and are each coupled to a spindle nut 50 which is non-rotatably mounted on the base plate 10. It would also be conceivable that the base plate 10 is moved only by a spindle element 9, wherein additionally guide rods can then be provided for guiding movement. Generally, the third embodiment is characterized in that the drive element 8 drives the toothed belt 48 and the base plate 10 is movably supported via the spindle element 49 on the handle support 9 between the basic position and the standby position. The spindle elements 49 are non-rotatably connected to the toothed belt pulleys 48 driven by the toothed belt 47, wherein the toothed belt pulleys 48 are rotatably mounted on the handle support 9. Furthermore, the spindle elements 49 interact with the spindle nuts 50 which are non-rotatably mounted on the base plate 10. In FIGS. 29 to 31, a the extension movement of the handle 4 is shown, wherein, in FIG. 29, the handle 4 is arranged in its idle position and the base plate 10 is arranged in its normal position, whereas in FIG. 30 intermediate positions for the base plate 10 and the handle 4 are shown before both are moved with the help of the belt drive in the handling position or operating position.

In summary, a door handle assembly 3 according to the present invention has been described above for three embodiments. The door handle assembly 3 is intended for use in a motor vehicle 1 and comprises—regardless of the embodiment—the handle support 9, the handle 4 and the drive element 8 attached to the handle support 9. The handle 4 can assume at least an idle position and a handling position. In case of installation in a vehicle door 2, the handle 4 extends flush with the outside 7 of the vehicle door 2 in the idle position and projects outward in a projection direction 14 relative to the outside 7 of the vehicle door 2. The invention is characterized in that a base plate 10 is movably mounted on the handle support 9, which is movable relative to the handle support 9, wherein said base plate can be moved relative to the handle support, and the handle 4 is mounted on said base plate. The movement of the base plate 10 takes place during a movement from the basic position into the actuating position in the projection direction 14, wherein a return spring returns the base plate 10 to its basic position. The drive element 8 is kinematically coupled to the base plate 10, wherein, in normal operation, the drive element 8 is designed to move the base plate 10 from a basic position, in which the handle 4 is arranged in the idle position thereof, into a standby position, in which the handle 4 is arranged in the handling position thereof. The movement of the handle 4 in its handling position takes place against the force of a return spring, which holds the handle 4 in its idle position and returns to the rest position after its actuation.

The invention described above is, of course, not limited to the embodiments described and depicted. It is evident that numerous modifications can be made to the embodiments shown in the drawing, which are obvious to the skilled person according to the intended application, without leaving the scope of the invention. The invention includes everything that is contained in the description and/or depicted in the drawing, including anything that, deviating from the concrete design examples, is obvious to the skilled person.

1. Door handle assembly for a motor vehicle, comprising a handle support, a handle and a drive element, wherein the handle can assume at least an idle position and a handling position, and wherein, in case of installation in a vehicle door, the handle extends flush with the outside of the vehicle door in the idle position and projects outward in a projection direction relative to the outside of the vehicle door for actuation in the handling position,
wherein
a base plate is movably mounted on the handle support, which is movable relative to the handle support, wherein said base plate can be moved relative to the handle support, and the handle is mounted on said base plate,
wherein the drive element is kinematically coupled to the base plate and in normal operation, the drive element is designed to move the base plate from a basic position, in which the handle is arranged in the idle position thereof, into a standby position, in which the handle is arranged in the handling position thereof.

2. Door handle assembly according to claim 1, wherein the handle is arranged unmoved on the base plate upon a movement of the base plate from the basic position to the standby position, wherein the base plate is designed to move the handle from the idle position into the handling position.

3. Door handle assembly according to claim 1, wherein the handle is mounted on the base plate, said handle being movably relative to the base plate, wherein a first longitudinal end of the handle is pivotally mounted on the base plate, whereas a second longitudinal end of the handle can be pivoted by an operator in a projection direction and is connected to a vehicle door opening means.

4. Door handle assembly according to claim 1, wherein the handle is designed to be movable from the idle position into an emergency operating position, in which a first portion of the handle moves contrary to the projection direction and a second portion of the handle projects outward in a projection direction relative to the outside of the vehicle door.

5. Door handle assembly according to claim 4, wherein the handle has a handle outer shell and a handle main lever, wherein a first longitudinal end of the handle outer shell is pivotally mounted at a first longitudinal end of the handle main lever, wherein the handle main lever is pivotally mounted on the base plate with its first longitudinal end, and wherein in the emergency operating position of the handle, the first longitudinal end of the handle outer shell is arranged to be movable opposite to the projection direction and the first longitudinal end of the handle outer shell is arranged to be relatively movable to the first longitudinal end of the handle main lever.

6. Door handle assembly according to claim 5, wherein a latching recess is formed at a second longitudinal end of the handle outer shell, wherein a safety lever blocking a relative movement between the handle outer shell and handle main lever is pivotally mounted with a latching hook on the handle main lever, and wherein the latching hook is engaged with the latching recess in the handling position of the handle.

7. Door handle assembly according to claim 6, wherein a moving web is formed on the handle support and the safety lever, which is disengaged from the locking recess in the idle position of the handle, is pivotally mounted about the axis on the handle main lever, wherein the moving web is designed to pivot the safety lever during the movement of the handle from the idle position into the handling position of the handle about the axis and to engage the latching hook with the latching recess in the handling position of the handle.

8. Door handle assembly according to claim 1, wherein the drive element rotatably drives a drive axis and the base plate is movably supported via the rotary joint on the handle support between the basic position and the standby position, wherein the at least one rotary joint is non-rotatably connected to a drive axis.

9. Door handle assembly according to claim 8, wherein the at least one rotary joint is designed to be lever-shaped and a respective first lever end of the rotary joint is rotatably connected to the base plate, whereas a second lever end of the rotary joint is both non-rotatably mounted to the drive shaft and rotatably mounted on the handle support 9.

10. Door handle assembly according to claim 1, wherein the base plate is movably guided between the basic position and the standby position along at least one guide rod extending transversely to the handle support.

11. Door handle assembly according to claim 10, wherein the drive element is coupled for movement with a drive lever which is rotatably mounted about a lever axis on the handle support, wherein, at its free end, the drive lever has a drive pin extending transversely to the projection direction which is arranged in a slot formed in the base plate, that the drive element moves the drive pin via the drive lever within the slot while the drive pin presses the base plate into its standby position.

12. Door handle assembly according to claim 11, wherein the drive element drives a coupling lever which is rotatable about a rotation axis in normal operation, wherein a free end of the coupling lever is formed with a coupling pin, which abuts the drive lever in a movement of the handle from the idle position in the handling position and rotates said lever about its lever axis.

13. Door handle assembly according to claim 12, wherein the coupling pin is arranged in a pin receptacle formed on the drive lever in the standby position of the base plate, wherein a movement of the base plate is blocked from the standby position into the projection direction when the coupling pin is arranged in the pin receptacle.

14. Door handle assembly according to claim 1, wherein the drive element drives a toothed belt and the base plate is movably supported via at least one spindle element on the handle support between the basic position and the standby position, wherein the at least one spindle element is non-rotatably connected to a toothed belt pulley driven by the toothed belt.

15. Door handle assembly according to claim 14, wherein the toothed belt pulley is rotatably mounted on the handle carrier and the at least one spindle element cooperates with a spindle nut which is rotatably mounted on the base plate.

16. Door handle assembly according to claim 14, wherein a spindle nut is rotatably mounted at a respective longitudinal end of the base plate, which spindle nut cooperates with the at least one spindle element which is non-rotatably connected to a toothed belt pulley which is rotatably mounted on the handle support.
